(19) United States
(12) Patent Application Publication
(10) Pub. No.: US 2008/0228160 A1
(43) Pub. Date: Sep. 18, 2008

(54) ESSENTIAL HOME PHARMACY KITS

(76) Inventor: CHAD E. HARRISON, TULSA, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/046,900

(22) Filed: Mar. 12, 2008

Related U.S. Application Data
(60) Provisional application No. 60/906,414, filed on Mar. 12, 2007.

(51) Int. Cl. A61J 1/03; B65D 83/04

(52) U.S. Cl. 604/404; 206/539

(57) ABSTRACT

A home pharmacy kit provided to organize, educate, simplify and add convenience to the consumer regarding self-treatment with over-the-counter (OTC) drugs and self-management of therapy with widely and commonly used OTC medications. The kit of the invention allows a consumer to achieve appropriate therapy when self-medicating and allows a consumer to avoid therapeutic duplication and over utilization and/or underutilization of medications, which may result from a lack of consumer related to the action and effects of common active ingredients found in a wide variety of cold and cough combination drug products as well as in gastrointestinal combination drug products.

### CROSS REFERENCE TO RELATED APPLICATIONS

This application claim the benefit of U.S. Provisional Patent Application No. 60/906,414 entitled “ESSENTIAL HOME PHARMACY KIT,” filed Mar. 12, 2007, the contents of which are hereby incorporated by reference.

### FIELD OF THE INVENTION

The present invention relates to a kit and method for providing single active ingredient cold and cough medicine that allows a consumer to combine or choose a tailored individual symptomatic therapy.

### BACKGROUND OF THE INVENTION

Sources indicate that Americans spend $500 to $700 million annually on over-the-counter products to obtain relief from the symptoms associated with the common cold. One market research company reports that over 1400 over-the-counter cough, cold, and flu products are available on the market. The multitude of cough, cold and allergy products have resulted in a confusing situation for the consumer. One reason for the confusion is the large number of products and brands. A second reason for consumer confusion is that most cough, cold, and allergy products have multiple pharmaceutical ingredients for treating more than one symptom. An additional cause of concern is that several of the pharmaceutical ingredients in cold, cough, and allergy products are not recommended for patients who have certain conditions such as high blood pressure or diabetes or who are on other medications that could interact. One study undertaken to help health professionals such as pharmacists in rendering services such as counseling consumers when approached with questions about cold, cough, and allergy products discussed the above status with respect to cold, cough, and allergy medications may be found in the “Journal of Hospital Marketing”, Vol. 13(1) 1999, entitled “OTC Cold, Cough and Allergy Products: More Choice of More Confusion?”.

### SUMMARY OF THE INVENTION

It is desirable to provide a plurality of single active ingredient drugs in kit form with a correlator to allow a patient to easily select drugs for treating particular symptoms while avoiding the taking of any drugs that are not required to alleviate a patient's particular symptoms. The kit of the present invention is an organized system of single active ingredient “over-the-counter (OTC) Cold and Cough” and/or “Gastrointestinal” type medications distributed in individual bottles, packaged as a singularly contained kit and/or individually with the potential to form a kit by category, which may be designated by color-coding or other designations. Preferably, the bottle holders are constructed from interconnected wood, plastic or cardboard, which, when connected, form an organizer that displays easily understandable indications for each medication. In addition to facilitating the correct combination of single active ingredient medications to treat particular symptoms, the kit also facilitates the correlation of correct single active ingredient medication for treating a particular symptom, in the event only a single medication is required.

### BRIEF DESCRIPTION OF THE DRAWINGS

FIG. 1 is a front elevation view of a medication holder of the invention.

FIG. 2 is a second embodiment of a medication holder of the invention.

FIG. 3 is a third embodiment of a medication holder of the invention.

FIG. 4 is a sample medication comparison chart of the invention.

### DETAILED DESCRIPTION OF THE PREFERRED EMBODIMENTS

The present invention relates to an “Essential Home Pharmacy Kit.” The kit preferably includes the following components:

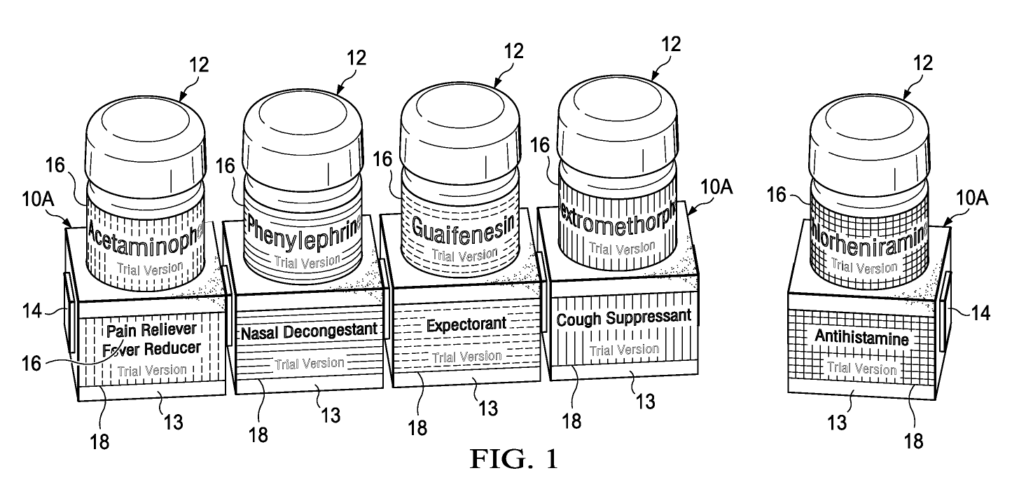

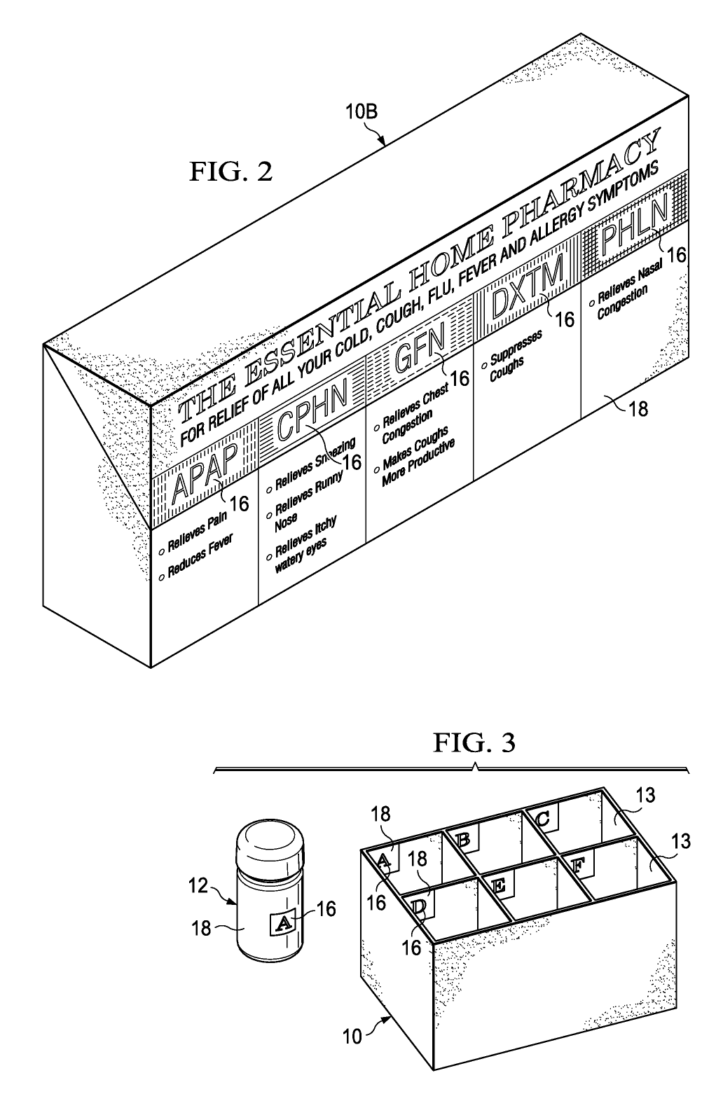

1. As shown in FIG. 1 connectable and detachable organizer/holders 10a or a single container 10b (FIGS. 2, 3), each of which are designed to hold a particular number of containers 12, such as bottles, blister packs, or other containers. Holder 10 may include connectable and detachable receptacles 13 connectable via attachment mechanisms 14. Attachment mechanism 14 may be magnets, hook and loop fasteners, tongue and groove surfaces, or other attachment mechanisms. Each container 10 preferable has a category indicator 16, such as label 18 affixed thereto. The category indicators 16 may be colors, symbols, or other indicators that can be affixed to holders 10 and containers 12 for facilitating ease of correlation of a class of drug indicated by category indicator 16 and the corresponding container 12 located in the correct receptacle 13. Classes of drug preferably include expectorant, pain reliever, decongestant, antitussive, and antihistamine. The listed classes of drugs may also double as symptomatic references, or more detailed symptomatic references may be listed as shown on labels 18 on container 10b of FIG. 2, thereby facilitating the correlation of symptomatic references with a correct class of drug.

In one embodiment, medication, e.g., tablets, within a container 12 are color coded to match a color of the corresponding label 18.

2. Containers 12 preferably each contain an FDA approved brand or generic form of a single active ingredient medication by category.

3. One of containers 12 preferably includes an expectorant (preferably guaifenesin, but may include alternative medications) for chest congestion.

4. One of containers 12 preferably includes a pain reliever, fever reducer (preferably acetaminophen, ibuprofen, naproxen, or aspirin, but may include alternative medications) for headache, muscle aches, arthritis, backache, toothaches, fever, sore throat.

5. One of containers 12 preferably includes a decongestant (preferably phenylephrine or pseudoephedrine, but may include alternative medications) for sinus congestion.

6. One of containers 12 preferably includes an antitussive, e.g., dextromethorphan, for cough, or other suitable medications for cough.

7. One of containers 12 preferably includes an antihistamine (preferably chlorpheniramine, diphenhydramine, loratadine, doxylamine, bropheniramine, or clemastine, but may include alternative medications) for runny nose, itching, watery eyes, hives, rashes.

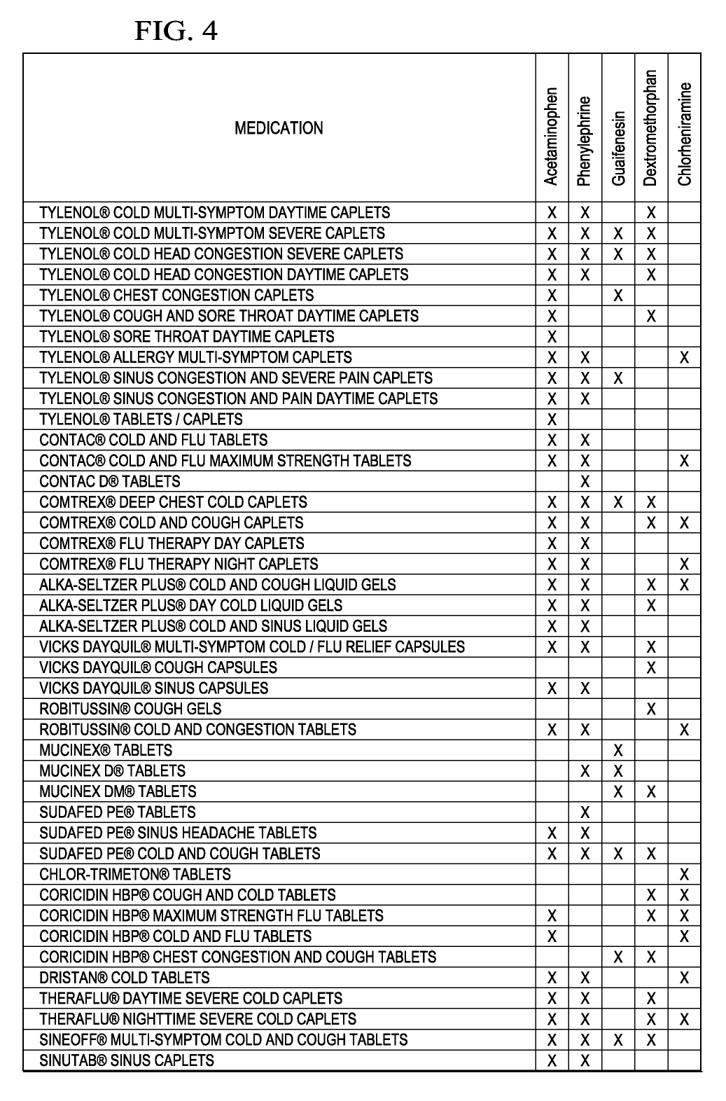

8. Referring to FIG. 4, it is desirable to include a comparison chart for comparing the above listed single active ingredient drugs to popular OTC medications that contain one or more of these active ingredients.

9. Symptom and active ingredient categories or drug classes are preferably designated on coded labels 18 that have a category indicator 16, such as color, or other indicators, which match the color and/or indicator of the respective holder 10 having a matching category indicator 16 for easy self diagnosis and appropriate medicine combination choice.

Examples of medication that may be used include acetaminophen, chlorpheniramine, phenylephrine, Ibuprofen, dyphenhydramine, pseudophedrine, phenylephrine, dextromethorphan, guaifenesin, or other medications.

The present invention encompasses all possible forms of medication dosing, including tablets, capsules, gelcaps, geltabs, liquids, effervescent tablets which can be dissolved in liquid, powder packets which can be dissolved in liquid, chewable tablets, dissolving tablets, and/or “thin strip” dosage forms. Effervescent tablets and powder packets each will be designed and packaged so that the different active ingredients may be added and dissolved together, for given symptoms, so that each resulting concoction is unique for each individual. Each concoction will include only specifically chosen active ingredients. A kit may include additionally, varied flavor packets that may be added to the concoction to achieve a particular flavor as desired according the individual preference of the consumer.

All dosage strengths, dosage forms and dosage regimens preferably follow current FDA approved guidelines for each medication and indication.

The components of the inventive kit work together to enhance the understanding of consumers regarding the safe and effective therapeutic usage of common OTC medication active ingredients. Use of the kit will lead to an improvement in the consumer's self treatment and self management of OTC cold and cough medications, thereby assuring the consumer's ability to achieve appropriate therapy and to avoid therapeutic duplication and therapeutic misuse of the OTC cold and cough medications. The majority of OTC cold and cough medications that are currently marketed and sold in combinations of one or more active ingredients, which results many times in unknowledgeable consumers not receiving appropriate symptomatic therapy, due to a consumer's selection and administration of combination drug products potentially being based on such factors as marketing, lay opinion/advice and/or guess work, as opposed to appropriate active ingredient selection. This invention works also by aiding those consumers who may be currently combining various OTC drug products already, without proper instruction.

The components of this invention work together to simplify a consumer's medication selection process, given the fact that many consumers are unknowledgeable as to the action and effects of active ingredients of OTC cold and cough medications. The available selection of OTC cold and cough combination products, which contain one or more active ingredients, is quite extensive and may be confusing and overwhelming to many consumers, which can cause a consumer to spend a considerable amount of time when trying to decide on a particular and appropriate OTC cold and cough therapy medication. To simplify this process, the Essential Home Pharmacy cold and cough “starter” or “basic” kit will preferably include acetaminophen, phenylephrine, clorpheniramine, guaifenesin and dextromethorphan, which will give the consumer over 30 possible unique combination therapy choices, accounting for the vast majority of all OTC cough and cold combination drug products currently available.

The components of this invention work together to add convenience of OTC cold and cough medication therapy to the consumer by allowing for different symptoms to be treated by different combinations of these single active ingredient medications in the combination choice of the consumer, therefore saving the consumer the need to buy additional OTC cold and cough combination products each time new symptoms arise, or as symptoms change or evolve, which also results in less frequent visits to purchase medication as new symptoms arise, or as symptoms change or evolve.

The present invention also releases the consumer from the current restriction imposed upon the consumer by combination drug therapy, which obligates the consumer to take all ingredients of a combination drug product in relative equal therapeutic dosing proportions, thus not allowing the consumer to decide if one particular symptom is requiring a higher or lower dose for its relief than another symptom. Consumers currently taking combination drug products must choose to either take more of one medication to get enough of the other(s), or not enough of one medication in order to not over utilize the other(s).

A second embodiment utilizes an alternative kit similar to the previous embodiment in purpose and functionality but with the medications in liquid form for child dosing therapy. This kit will also contain a syringe measuring device, similar to current syringe measuring devices available. However, the syringe may be larger to accommodate an increased liquid volume if medications are deemed appropriate to be added together for the given symptoms, or the medicine will be of a higher concentration in order to limit the need for increased liquid volume, all of which will allow for easy and accurate measuring and dosing from the medication bottles.

A third embodiment utilizes an alternative kit similar to the first embodiment in purpose and functionality but with limited and specifically targeted single active ingredient medications deemed safe for women who are pregnant. This kit offers symptomatic therapy for pregnant women who are concerned about potentially harmful medication ingredients as classified by the FDA. This kit will help to educate consumers, many of which are unfamiliar with active ingredients of medications and their classification with the FDA regarding pregnancy, so they may more appropriately achieve safe cold and cough symptomatic therapy. Safe therapy is defined as any drug that is rated by the FDA as a class A or class B as being therapeutically safe for women who are pregnant. This kit is comprised of the following medications: acetaminophen (class B) and chlorpheniramine (class B).

Preferably, each medication that forms a part of the kit will be made available separately, so that a consumer will be able to replace depleted medications without having to purchase a complete new kit.

A fourth embodiment of the present invention utilizes an alternative kit similar to the original invention in purpose and functionality but with limited and specifically targeted single active ingredient medications deemed safe for consumers diagnosed with high blood pressure. This kit offers symptomatic therapy for consumers with high blood pressure who are concerned about potentially harmful medication ingredients as classified by the American Heart Association. This kit will help to educate consumers, many of whom are unfamiliar with active ingredients of medications and the classification of the medications with the AHA regarding high blood pressure. By using the inventive kit, consumers may more appropriately achieve safe cold and cough symptomatic therapy. Safe therapy is defined as any drug that is an approved cold and cough medication by the AHA, which organization specifically discourages OTC decongestants. This kit is preferably comprised of the following medications: acetaminophen, chlorpheniramine, dextromethorphan, guaifenensin.

A fifth embodiment utilizes a kit similar to the first embodiment of the present invention in general purpose and functionality but containing bottles of single active ingredient medications that are used in gastrointestinal related symptomatic therapy, many of which are also found and can be purchased in combination products, which again may lead to confusion and complication to the consumer. This set is comprised of the following medications:

1. Acid reducer (preferably ranitidine, cimetidine, or famotadine, but may include alternative medications) for treating acid reflux.

2. Stool softener (preferably docusate sodium or docusate calcium, but may include alternative medications) for treating constipation due to hard stools.

3. Antidiarreal (preferably loperamide, but may include alternative medications) for treating diarrhea.

4. Anti-gas (preferably simethicone, but may include alternative medications) for treating gas pressure.

5. Laxative (preferably bisacodyl or senna, but may include alternative medications) for treating constipation.

6. Antacid (preferably calcium carbonate and/or magnesium hydroxide, but may include alternative medications) for treating heartburn.

Containers 12 of medicine may come with or without a container holder/organizer 10. Organizer 10 may be a designed to hold five or more or less containers 12. Alternatively, to ensure a consumer's ability to make individual preferences among same category active ingredient medications and for any other individual preferences, consumers may customize their own Essential Home Pharmacy kit. The container 12 holders/organizers 10 may be constructed so that each of the individual wood, plastic or cardboard medicine receptacles 13 can be removed or added, side by side and/or back to back, as the consumer desires. Individual receptacles 13 that contain a single container 12 of medication are preferably coded with a category indicator 16. Each recepticle 13 may be constructed with a simple design of interconnectivity, such as with thin magnets attached the sides of the receptacles 13, or other possible methods, thus allowing a consumer to quickly and easily connect and disconnect the receptacles 13 with other Essential Home Pharmacy receptacles 13. In this way, consumers may customize their own Essential Home Pharmacy kit according to their individual preferences of single active ingredient medications. Containers 12 of medication may also be available individually or packaged together as a kit without the holder/organizer 10. Alternatively, the holders 10 may make up a single package. Cardboard packaging is preferred, although other materials may be used, including wood or plastic.

All medication receptacles 13 should have a clear and understandable display, e.g., label 18, located in front of the receptacle 13 that will be attached to or be part of the receptacle 13. Label 18 preferably will state the name, the indications, and the dosing information of the medication. Containers 12, e.g., medication bottles and bottle holders, of the same category of single active ingredient medications may be of similar color. However, indications of differences in actual active ingredient may be presented by varied shades of a particular color or by other obvious markings on the bottle and the bottle holder.

All individual containers 12 will preferably be available for purchase individually to replace empty containers 12 within the respective set as they are used up.

In addition to the embodiments of the present invention described above, smaller versions of the previous embodiments having the medications in any oral or “thin strip ” other form, may be provided that can be easily carried and will be specifically useful for allowing consumers to take medication with them as they desire.

In addition to OTC medications, the Essential Home Pharmacy may include other categories of OTC products, such as vitamins, diet aids, and/or other supplements, of which the components will be compatible with other Essential Home Pharmacy products, in which larger kits may be formed.

A comparison guide (FIG. 3) is preferably provided for comparing well known OTC cold and cough and gastrointestinal name brand combination medications that list the active ingredients of each so the consumer may then match those active ingredients with those in the Essential Home Pharmacy kit in order to receive a comparable therapy as desired.

The bottle holders/organizers 10 may change in their specific design due to marketability and/or logistical reasons given that the essence of this invention is not the technical design of the bottle holders/organizers but rather a solution to the overdue need for education and simplification of current OTC cold and cough combination drug therapy market, which currently is not only unnecessarily confusing and time consuming to most consumers, but potentially dangerous to consumers who lack the knowledge of the active ingredient names, actions and effects found in these products.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A medication kit comprising:
a plurality of single active ingredient drugs, each single active ingredient drug in a separate container, each separate container having a category indicator thereon;
a correlator for correlating said category indicators with symptomatic references, said correlator for indicating which combination, if any, of said single active ingredient drugs should be taken in combination to relieve specific symptoms listed in said symptomatic reference.

2. The medication kit according to claim 1 wherein:
said kit includes a holder having detachable interconnecting receptacles that may be connected in a desired configuration, each of said receptacles for receiving one of said containers.

3. The medication kit according to claim 2 wherein:
said kit includes a holder that is comprised of a plurality of receptacles, each of said receptacles displaying one of said category indicators for facilitating easy coordination with one of said containers having a like category indicator thereon.

4. The medication kit according to claim 3 wherein said holder is designed for use as a permanent organizer for said containers and for like replacement containers once said containers are in need of replacement.

5. The medication kit according to claim 1 further comprising:
a reference chart for comparing popular “over-the-counter” medications that include one of said plurality of single active ingredient drugs as an active ingredient.

6. The medication kit according to claim 1 wherein said category indicator is a color.

7. The medication kit according to claim 6 wherein:
said single active ingredient drug is colored to match the color of a corresponding one of said category indicators.

8. The medication kit according to claim 1 wherein:
said category indicators distinguish between classes of drugs selected from the group comprising an expectorant, a pain reliever, a decongestant, an antitussive, and an antihistamine.

9. The medication kit according to claim 1 wherein:
said category indicators distinguish between classes or drugs selected from the group comprising an acid reliever, a stool softener, an anti-diarrheal, an anti-gas, a laxative, and an antacid.

10. A method of delivering symptom specific drugs to a patient comprising the steps of:
providing a plurality of containers, each container having a single active ingredient medication therein;
locating said plurality of containers in a holder having a plurality of receptacles, each receptacle for receiving one of said containers;
providing a correlator to allow a person to correlate symptoms with appropriate containers so that the patient may select medication from an appropriate container.

11. The method according to claim 10 wherein:
said correlator comprises a category indicator affixed to said receptacle and a matching category indicator affixed to an appropriate container.

12. The method according to claim 11 wherein:
said category indicator is a color.

13. The method according to claim 12 wherein:
said single active ingredient drug is colored to match the color of a corresponding one of said category indicators.

14. The method according to claim 11 wherein:
said category indicator is a symbol.

15. The method according to claim 11 wherein:
said category indicators distinguish between classes of drugs selected from the group comprising an expectorant, a pain reliever, a decongestant, an antitussive, and an antihistamine.

16. The method according to claim 11 wherein:
said category indicators distinguish between classes or drugs selected from the group comprising an acid reliever, a stool softener, an anti-diarrheal, an anti-gas, a laxative, and an antacid.
